(19) United States
(12) Patent Application Publication
(10) Pub. No.: US 2020/0264781 A1
(43) Pub. Date: Aug. 20, 2020

(54) LOCATION AWARE MEMORY WITH VARIABLE LATENCY FOR ACCELERATING SERIALIZED ALGORITHM

(71) Applicant: Nanjing Iluvatar CoreX Technology Co., Ltd. (DBA “Iluvatar CoreX Inc. Nanjing”), Nanjing (CN)

(72) Inventors: Cheng Li, San Jose, CA (US); Pingping Shao, San Jose, CA (US); Pei Luo, San Jose, CA (US)

(73) Assignee: Nanjing Iluvatar CoreX Technology Co., Ltd. (DBA “Iluvatar CoreX Inc. Nanjing”), Nanjing (CN)

(21) Appl. No.: 16/281,055

(22) Filed: Feb. 20, 2019

(51) Int. Cl. G06F 3/06

(52) U.S. Cl. CPC G06F 3/0611; G06F 3/0673; G06F 3/0659

(57) ABSTRACT

Embodiments of the invention may provide a technical solution by reassigning memory access as a function of physical location information of a memory group. A physical location of an agent in a multi-agent system is first identified. Memory access requests from instructions of the agent are determined. In another embodiment, based on the physical location of the agent, a scheduler may determine a group of memory units having a physical location that is closest to the physical location of the agent. The scheduler may then assign the determined memory access requests to the group of memory units.

### TECHNICAL FIELD

Embodiments of the invention generally relate to providing a physical location-aware memory configuration for serialized algorithms.

### BACKGROUND

Scalar processing processes only one data item at a time, with typical data items being integers or floating point numbers. Typically, a scalar processing is classified as a SISD processing (Single Instruction, Single Data). Another variation of this approach is a single instruction, multiple tread (SIMT) processing. Conventional SIMT multithreaded processors provide parallel execution of multiple threads by organizing threads into groups and executing each thread on a separate processing pipeline, scalar or vector pipeline. An instruction for execution by the threads in a group dispatches in a single cycle. The processing pipeline control signals are generated such that all threads in a group perform a similar set of operations as the threads traverse the stages of the processing pipelines. For example, all the threads in a group read source operands from a register file, perform the specified arithmetic operation in processing units, and write results back to the register file. SIMT requires additional memory for replicating the constant values used in the same kernel when multiple contexts are supported in the processor. As such, latency overhead is introduced when different constant values are loaded from main memory or cache.

It is also understood that in the overall calculation of processing time and latency, access to memory is an important part of the overall calculation. It is also well-known that for a desirable speed, chips have now included memory or storage units therein such that the physical distances are greatly minimized. However, it is not cost-effective to include memory units with large storage capacities on the chip. As such, there will be memory units that are located, while connected via bus, outside the chip and on system memory banks/units or other storage units, such as hard drive, solid state drives (SSD), etc.

Furthermore, in today's world, a typical enterprise application will have multiple components and will be distributed across various systems and networks. If two components want to communicate with each other, there needs be a mechanism to exchange data. One way to achieve this is to define your own protocol and transfer an object. This means that the receiving end must know the protocol used by the sender to re-create the object, which would make it very difficult to talk to third-party components. Hence, there needs to be a generic and efficient protocol to transfer the object between components. Serialization is defined for this purpose to use this protocol to transfer objects.

Therefore, average memory access latency may be created as overhead due to balanced access delays among memory macros having different physical distances that are used to compose large and high-performance memory array. Moreover, unnecessary power consumptions on global interconnects in the memory array with balanced access latency when only small portion of the memory is accessed. Additional latency and power consumption is more disadvantageous when on-chip memory is shared by multiple agents that are physically distant on the chip.

Therefore, embodiments of the invention attempt to solve or address one or more of the technical problems identified above.

### SUMMARY

Embodiments of the invention may provide a technical solution by dividing, compartmentalizing, or breaking large-size memory banks or arrays into smaller memory macros grouped based on these macro's physical locations, both horizontal and vertical and based on corresponding access latency cycles to the interfaces of each agent. In one embodiment, granularities of the smaller memory groups may be determined by a performance target and the area overhead that the design may afford.

In a further embodiment, for latency-critical serialized algorithms, smaller memory groups may be allocated to regions with smaller latency whenever possible to corresponding agents. Non-latency-critical threads or less frequently accessed memory banks/arrays may be allocated to a relatively farther memory groups away from the agents to save overall latency and power.

Furthermore, memory access from different agents may be scheduled in a way that accesses to each agent's closest memory groups may have the highest priority. In addition, multi-channel buffers may each include a memory group to avoid return path conflict and may be configured to achieve lowest latency or highest bandwidth capability.

### BRIEF DESCRIPTION OF THE DRAWINGS

Persons of ordinary skill in the art may appreciate that elements in the figures are illustrated for simplicity and clarity so not all connections and options have been shown to avoid obscuring the inventive aspects. For example, common but well-understood elements that are useful or necessary in a commercially feasible embodiment may often not be depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein may be defined with respect to their corresponding respective areas of inquiry and study except where specific meanings have otherwise been set forth herein.

FIG. 1 is a diagram illustrating a prior art approach to memory location arrangements.

FIG. 2 is a diagram illustrating memory macro groups according to one embodiment of the invention.

FIG. 3 is a diagram illustrating a data content of a new macro memory group buffer according to one embodiment of the invention.

FIG. 4 is a flow chart illustrating a method for reassigning memory access as a function of physical location information of a memory group according to one embodiment of the invention.

FIG. 5 is a block diagram illustrating a computer system configured to implement one or more aspects of the present invention;

FIG. 6 is a block diagram of a parallel processing subsystem for the computer system of FIG. 5, according to one embodiment of the present invention.

### DETAILED DESCRIPTION

The present invention may now be described more fully with reference to the accompanying drawings, which form a part hereof, and which show, by way of illustration, specific exemplary embodiments by which the invention may be practiced. These illustrations and exemplary embodiments may be presented with the understanding that the present disclosure is an exemplification of the principles of one or more inventions and may not be intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

In general, a computational core (see GPC 514 below) utilizes programmable vertex, geometry, and pixel shaders. Rather than implementing the functions of these components as separate, fixed-function shader units with different designs and instruction sets, the operations are instead executed by a pool of execution units with a unified instruction set. Each of these execution units may be identical in design and configurable for programmed operation. In one embodiment, each execution unit may be capable of multi-threaded operation simultaneously. As various shading tasks may be generated by the vertex shader, geometry shader, and pixel shader, they may be delivered to execution units to be carried out.

As individual tasks are generated, an execution control unit (may be part of the GPC 514 below) handles the assigning of those tasks to available threads within the various execution units. As tasks are completed, the execution control unit further manages the release of the relevant threads. In this regard, the Execution control unit is responsible for assigning vertex shader, geometry shader, and pixel shader tasks to threads of the various execution units, and also performs an associated “bookkeeping” of the tasks and threads. Specifically, the execution control unit maintains a resource table (not specifically illustrated) of threads and memories for all execution units. The execution control unit particularly manages which threads have been assigned tasks and are occupied, which threads have been released after thread termination, how many common register file memory registers are occupied, and how much free space is available for each execution unit.

A thread controller may also be provided inside each of the execution units, and may be responsible for scheduling, managing or marking each of the threads as active (e.g., executing) or available.

According to one embodiment, a scalar register file may be connected to the thread controller and/or with a thread task interface. The thread controller provides control functionality for the entire execution unit (e.g., GPC 514), with functionality including the management of each thread and decision-making functionality such as determining how threads are to be executed.

Moreover, as referred to in the following sections, an agent (e.g., 106 or 206) may be a physical or virtual entity that acts, perceive its environment and communicate with others, is autonomous and has skills to achieve its goals and tendencies in a multi-agent system (MAS). In such a MAS, MAS contains an environment, objects, and agents (the agents being the only ones to act), relations between all the entities, a set of operations that may be performed by the entities and the changes of the universe in time and due to these actions.

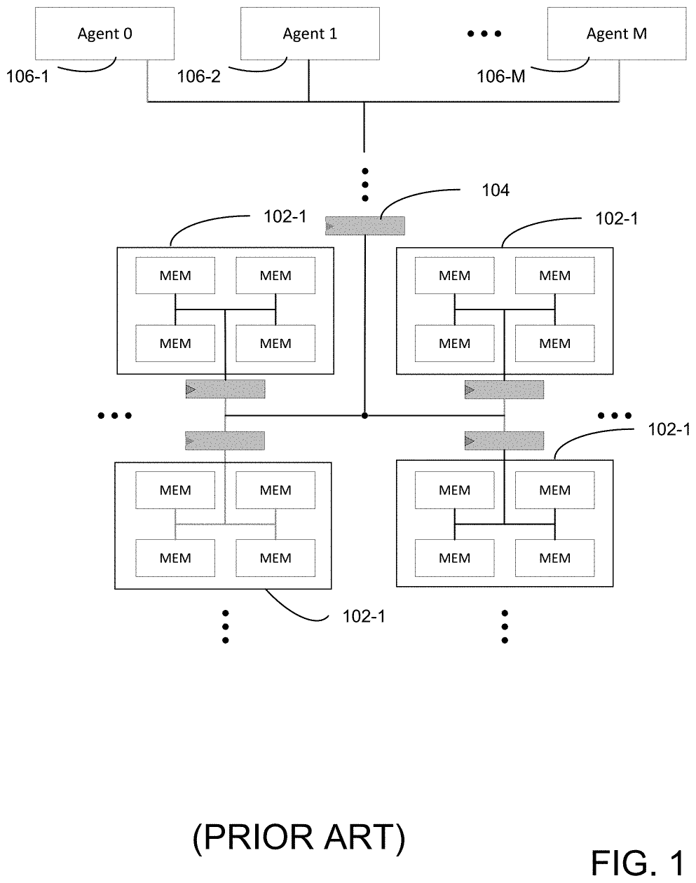

Referring now to FIG. 1, a diagram illustrates a prior approach to memory location managements. For example, agents 0 through M 106 may process tasks or threads where data may be stored in one or more memory banks 102. In one situation, algorithms in these agents 106 may manage or schedule memory read and/or write based on the availabilities of memory banks 102. However, a general purpose parallel runtime system typically includes its own scheduler or scheduling technique, such as a scheduler 104. For example, the agents 106 route all memory access requests or instructions to the scheduler 104 and the scheduler 104, based on its scheduling scheme, facilitate management and control of the memory banks between the agents 106 and the memory banks or units 102. While the scheduler 104 may be suitable to achieve average memory access latency, it is insufficient or inadequate for those parallel algorithm that is oblivious to memory or power consumption. Moreover, while there may be other memory-aware scheduler available, none of them takes into consideration of the physical locations or distances between the physical memory chips or storage unit and that of the processors or processing units. In one embodiment, the physical location information of the group of the memory units may identify a horizontal orientation information or a vertical orientation information relative to the agents 206.

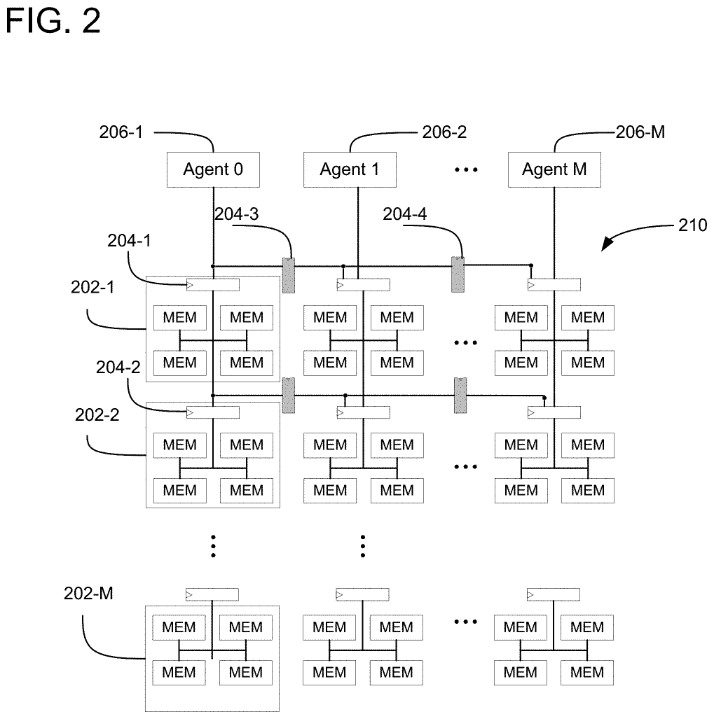

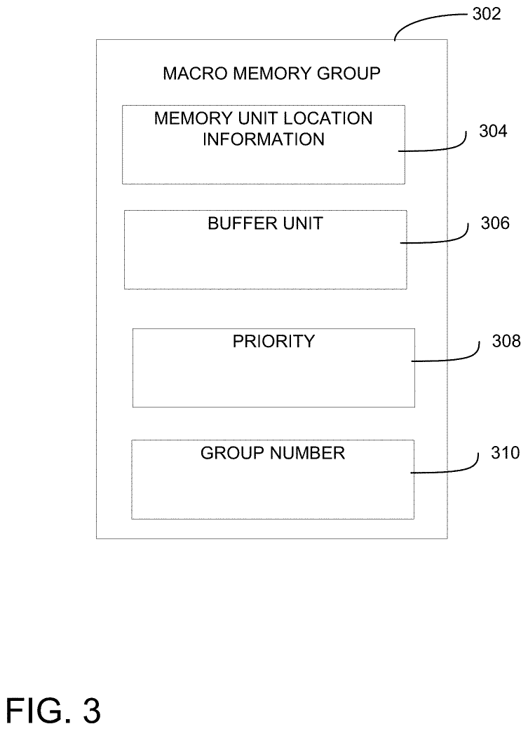

Referring to FIG. 2, a diagram illustrates location-aware memory scheduling according to one embodiment of the invention. For example, agents 206 may need to access memory banks 210. Instead of using existing scheduling algorithm or techniques, aspects of the invention modify existing memory schedule algorithm to add location-aware information to the scheduling. In another embodiment, aspects of the invention may create additional memory buffer units to hold memory location information. Also referring to FIG. 3, a diagram illustrates a data storage unit 302 storing information to achieve desirable results of aspects of the invention. For example, the unit 302 may store memory unit location information 304. For example, the memory unit location information 304 may include information as to the physical location of a group or set of memory units. In one example, the physical location may include memory block information, array socket number, or other reference number used to identify a particular memory unit. The unit 302 may further include information 306 relating to a buffer unit. For example, the buffer unit data 306 may be responsible for communicating with a scheduler, such as a scheduler 204. As such, the buffer unit data 306 may include an identification of the scheduler 204.

In another aspect of the invention, the unit 302 may further include priority information 308. For example, the scheduler 204 may receive information from the agent 206-1 that the agent 206-1 may be latency-critical serialized algorithms, as such, reduction of latency is highly desirable.

In one example, serialized algorithms may include the following program structure (in JAVA):

class parent implements Serializable {

int parentVersion = 10;

}
class contain implements Serializable{

int containVersion = 11;

}
public class SerialTest extends parent implements Serializable {

int version = 66;
contain con = new contain( );
public int getVersion( ) {

return version;

}
public static void main(String args[ ]) throws IOException {

FileOutputStream fos = new FileOutputStream(“temp.out”);
ObjectOutputStream oos = new ObjectOutputStream(fos);
SerialTest st = new SerialTest( );
oos.writeObject(st);
oos.flush( );
oos.close( );

}

}

In this example, serialization algorithms may:

write out the metadata of the class associated with an instance;

recursively write out the description of the superclass until it finds java.lang.object;

once it finishes writing the metadata information, it then starts with the actual data associated with the instance. But this time, it starts from the topmost superclass; and

recursively write the data associated with the instance, starting from the least superclass to the most-derived class.

It is to be understood that serialization algorithms written in other programming languages may be exhibit similar characteristics without departing from the scope or spirit of embodiments of the invention.

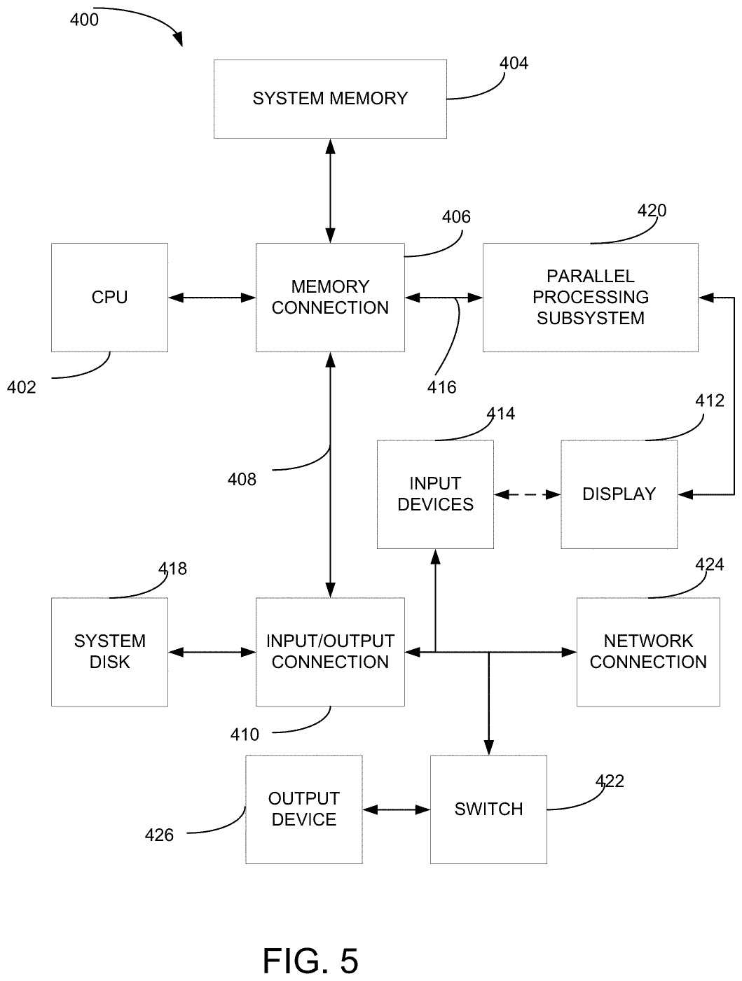

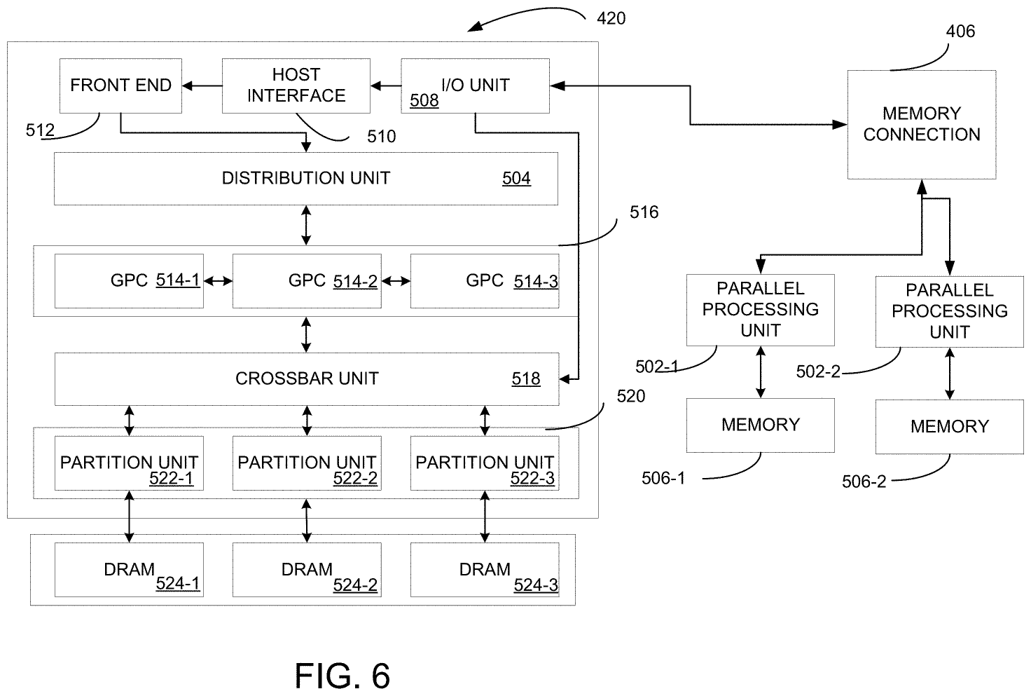

As such, the priority information 308 may rank priority needs for the agents 206. In another embodiment, the unit 302 may further include a group identifier 310 such as identifying the different macro groups of memory clusters. In another example, the unit 302 may not need to be a standalone memory unit or a memory buffer. Depending on the size of the memory banks, the unit 302 may be a small portion of the memory buffer system in FIGS. 5 and 6.

Referring again to FIG. 2, unlike FIG. 1 where all memory access needs are funneled through one scheduler, each of the agents 206's memory allocation and access scheduling are considered by one or more schedulers that consider physical distance and locations of groups 202-1, 202-2, and other groups 202 in the memory bank 210. For example, the schedulers 204 may access the data in the unit 302 to identify smaller memory groups and their respective physical location information. It is to be understood that the memory physical locations different from memory addresses that may be used for storing data. The physical locations of memory groups, for example, as discussed in this application relate to sometimes referred to as the “absolute” locations of the memory. As such, with such information, the scheduler 204 may read the data in the unit 302 to reassign identify the physical locations of the memory groups and, depending on the memory needs or access of the agents 206, configure memory groups depending on the relative physical locations of the memory groups 202. In a further example, the scheduler 204 includes information of each of the agents 206 and their physical location thereof. After reading the information of the locations of the agents 206, the scheduler 204 may determine from the data in the unit 302 the closest (physically) memory group within the overall memory cluster 210 to the agents 206. Based on such determination, the scheduler 204 may assign memory access to the determined group.

In another embodiment, the scheduler 204 may further include information about latency cycle needs or requirement of the agent. In one example, such information may be provided by the programmer. In another example, the scheduler 204 may obtain such information from other sources, such as previously provided history or heuristics on agents' accesses. Based on such additional information, the scheduler 204 may store, retrieve, or read the priority data in the unit 302 and assign the memory groups 206 in response to the presence of the priority information.

In an alternative embodiment, a multi-channel buffer for each of the memory groups may be used to avoid return path conflict and may be configured to achieve lowest latency or highest bandwidth.

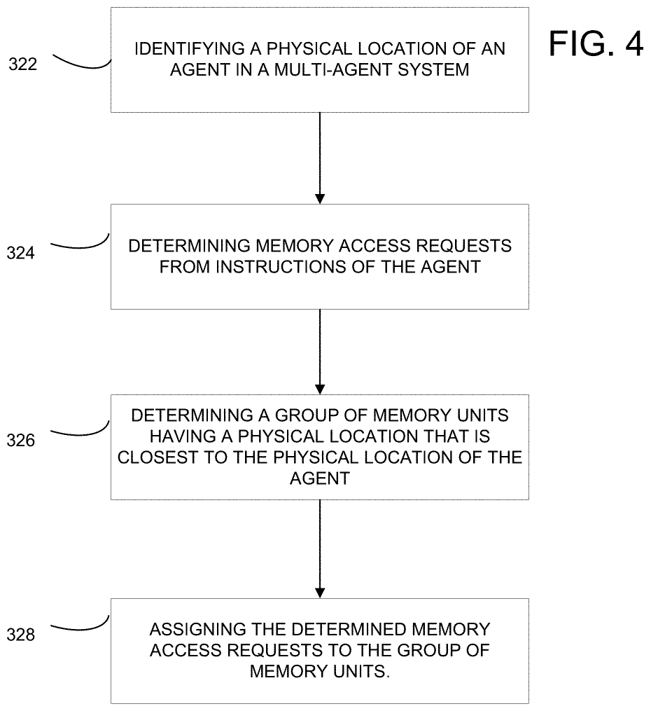

Referring now to FIG. 4, a flow chart illustrates a method for reassigning memory access as a function of physical location information of a memory group according to one embodiment of the invention. At 322, a scheduler, e.g., the scheduler 204, may identify a physical location of an agent in a multi-agent system. For example, as discussed above, the agent 206 may possess information about its physical location. The scheduler 204 may identify such information upon receiving memory access requests from the agents 206. At 324, the scheduler 204 may determine the memory access requests from instructions of the agent. For example, the scheduler 204 may determine the memory access needs by the agents 206 after examining and reviewing the instructions.

At 326, based on the physical location of the agent, the scheduler may further determine a group of memory units having a physical location that is closest to the physical location of the agent. At 328, the scheduler may further assign the determined memory access requests to the group of memory units.

FIG. 5 is a block diagram illustrating a computer system 400 configured to implement one or more aspects of the present invention. Computer system 400 includes a central processing unit (CPU) 402 and a system memory 404 communicating via an interconnection path that may include a memory connection 406. Memory connection 406, which may be, e.g., a Northbridge chip, is connected via a bus or other communication path 408 (e.g., a HyperTransport link) to an I/O (input/output) connection 410. I/O connection 410, which may be, e.g., a Southbridge chip, receives user input from one or more user input devices 414 (e.g., keyboard, mouse) and forwards the input to CPU 402 via path 408 and memory connection 406. A parallel processing subsystem 420 is coupled to memory connection 406 via a bus or other communication path 416 (e.g., a PCI Express, Accelerated Graphics Port, or HyperTransport link); in one embodiment parallel processing subsystem 420 is a graphics subsystem that delivers pixels to a display device 412 (e.g., a CRT, LCD based, LED based, or other technologies). The display device 412 may also be connected to the input devices 414 or the display device 412 may be an input device as well (e.g., touch screen). A system disk 418 is also connected to I/O connection 410. A switch 422 provides connections between I/O connection 410 and other components such as a network adapter 424 and various output devices 426. Other components (not explicitly shown), including USB or other port connections, CD drives, DVD drives, film recording devices, and the like, may also be connected to I/O connection 410. Communication paths interconnecting the various components in FIG. 5 may be implemented using any suitable protocols, such as PCI (Peripheral Component Interconnect), PCI-Express, AGP (Accelerated Graphics Port), HyperTransport, or any other bus or point-to-point communication protocol(s), and connections between different devices may use different protocols as is known in the art.

In one embodiment, the parallel processing subsystem 420 incorporates circuitry optimized for graphics and video processing, including, for example, video output circuitry, and constitutes a graphics processing unit (GPU). In another embodiment, the parallel processing subsystem 420 incorporates circuitry optimized for general purpose processing, while preserving the underlying computational architecture, described in greater detail herein. In yet another embodiment, the parallel processing subsystem 420 may be integrated with one or more other system elements, such as the memory connection 406, CPU 402, and I/O connection 410 to form a system on chip (SoC).

It will be appreciated that the system shown herein is illustrative and that variations and modifications are possible. The connection topology, including the number and arrangement of bridges, the number of CPUs 402, and the number of parallel processing subsystems 420, may be modified as desired. For instance, in some embodiments, system memory 404 is connected to CPU 402 directly rather than through a connection, and other devices communicate with system memory 404 via memory connection 406 and CPU 402. In other alternative topologies, parallel processing subsystem 420 is connected to I/O connection 410 or directly to CPU 402, rather than to memory connection 406. In still other embodiments, I/O connection 410 and memory connection 406 might be integrated into a single chip. Large embodiments may include two or more CPUs 402 and two or more parallel processing systems 420. Some components shown herein are optional; for instance, any number of peripheral devices might be supported. In some embodiments, switch 422 may be eliminated, and network adapter 424 and other peripheral devices may connect directly to I/O connection 410.

FIG. 6 illustrates a parallel processing subsystem 420, according to one embodiment of the present invention. As shown, parallel processing subsystem 420 includes one or more parallel processing units (PPUs) 502, each of which is coupled to a local parallel processing (PP) memory 506. In general, a parallel processing subsystem includes a number U of PPUs, where (Herein, multiple instances of like objects are denoted with reference numbers identifying the object and parenthetical numbers identifying the instance where needed.) PPUs 502 and parallel processing memories 506 may be implemented using one or more integrated circuit devices, such as programmable processors, application specific integrated circuits (ASICs), or memory devices, or in any other technically feasible fashion.

In some embodiments, some or all of PPUs 502 in parallel processing subsystem 420 are graphics processors with rendering pipelines that can be configured to perform various tasks related to generating pixel data from graphics data supplied by CPU 402 and/or system memory 404 via memory connection 406 and communications path 416, interacting with local parallel processing memory 506 (which can be used as graphics memory including, e.g., a conventional frame buffer) to store and update pixel data, delivering pixel data to display device 412, and the like. In some embodiments, parallel processing subsystem 420 may include one or more PPUs 502 that operate as graphics processors and one or more other PPUs 502 that are used for general-purpose computations. The PPUs may be identical or different, and each PPU may have its own dedicated parallel processing memory device(s) or no dedicated parallel processing memory device(s). One or more PPUs 502 may output data to display device 412 or each PPU 502 may output data to one or more display devices 412.

In operation, CPU 402 is the master processor of computer system 400, controlling and coordinating operations of other system components. In particular, CPU 402 issues commands that control the operation of PPUs 502. In some embodiments, CPU 402 writes a stream of commands for each PPU 502 to a pushbuffer (not explicitly shown in either FIG. 5 or FIG. 6) that may be located in system memory 404, parallel processing memory 506, or another storage location accessible to both CPU 402 and PPU 502. PPU 502 reads the command stream from the pushbuffer and then executes commands asynchronously relative to the operation of CPU 402.

Referring back now to FIG. 6, each PPU 502 includes an I/O (input/output) unit 508 that communicates with the rest of computer system 400 via communication path 416, which connects to memory connection 406 (or, in one alternative embodiment, directly to CPU 402). The connection of PPU 502 to the rest of computer system 400 may also be varied. In some embodiments, parallel processing subsystem 420 is implemented as an add-in card that can be inserted into an expansion slot of computer system 400. In other embodiments, a PPU 502 can be integrated on a single chip with a bus connection, such as memory connection 406 or I/O connection 410. In still other embodiments, some or all elements of PPU 502 may be integrated on a single chip with CPU 402.

In one embodiment, communication path 416 is a PCI-EXPRESS link, in which dedicated lanes are allocated to each PPU 502, as is known in the art. Other communication paths may also be used. An I/O unit 508 generates packets (or other signals) for transmission on communication path 416 and also receives all incoming packets (or other signals) from communication path 416, directing the incoming packets to appropriate components of PPU 502. For example, commands related to processing tasks may be directed to a host interface 510, while commands related to memory operations (e.g., reading from or writing to parallel processing memory 506) may be directed to a memory crossbar unit 518. Host interface 510 reads each pushbuffer and outputs the work specified by the pushbuffer to a front end 512.

Each PPU 502 advantageously implements a highly parallel processing architecture. As shown in detail, PPU 502(0) includes a processing cluster array 516 that includes a number C of general processing clusters (GPCs) 514, where C≥1. Each GPC 514 is capable of executing a large number (e.g., hundreds or thousands) of threads concurrently, where each thread is an instance of a program. In various applications, different GPCs 514 may be allocated for processing different types of programs or for performing different types of computations. For example, in a graphics application, a first set of GPCs 514 may be allocated to perform patch tessellation operations and to produce primitive topologies for patches, and a second set of GPCs 514 may be allocated to perform tessellation shading to evaluate patch parameters for the primitive topologies and to determine vertex positions and other per-vertex attributes. The allocation of GPCs 514 may vary dependent on the workload arising for each type of program or computation.

GPCs 514 receive processing tasks to be executed via a work distribution unit 504, which receives commands defining processing tasks from front end unit 512. Processing tasks include indices of data to be processed, e.g., surface (patch) data, primitive data, vertex data, and/or pixel data, as well as state parameters and commands defining how the data is to be processed (e.g., what program is to be executed). Work distribution unit 504 may be configured to fetch the indices corresponding to the tasks, or work distribution unit 504 may receive the indices from front end 512. Front end 512 ensures that GPCs 514 are configured to a valid state before the processing specified by the pushbuffers is initiated.

When PPU 502 is used for graphics processing, for example, the processing workload for each patch is divided into approximately equal sized tasks to enable distribution of the tessellation processing to multiple GPCs 514. A work distribution unit 504 may be configured to produce tasks at a frequency capable of providing tasks to multiple GPCs 514 for processing. By contrast, in conventional systems, processing is typically performed by a single processing engine, while the other processing engines remain idle, waiting for the single processing engine to complete its tasks before beginning their processing tasks. In some embodiments of the present invention, portions of GPCs 514 are configured to perform different types of processing. For example a first portion may be configured to perform vertex shading and topology generation, a second portion may be configured to perform tessellation and geometry shading, and a third portion may be configured to perform pixel shading in pixel space to produce a rendered image. Intermediate data produced by GPCs 514 may be stored in buffers to allow the intermediate data to be transmitted between GPCs 514 for further processing.

Memory interface 520 includes a number D of partition units 522 that are each directly coupled to a portion of parallel processing memory 506, where D≥1. As shown, the number of partition units 522 generally equals the number of DRAM 524. In other embodiments, the number of partition units 522 may not equal the number of memory devices. Persons skilled in the art will appreciate that DRAM 524 may be replaced with other suitable storage devices and can be of generally conventional design. A detailed description is therefore omitted. Render targets, such as 522-1 frame buffers or texture maps may be stored across DRAMs 524, allowing partition units 522 to write portions of each render target in parallel to efficiently use the available bandwidth of parallel processing memory 506.

Any one of GPCs 514 may process data to be written to any of the DRAMs 524 within parallel processing memory 506. Crossbar unit 518 is configured to route the output of each GPC 514 to the input of any partition unit 522 or to another GPC 514 for further processing. GPCs 514 communicate with memory interface 520 through crossbar unit 518 to read from or write to various external memory devices. In one embodiment, crossbar unit 518 has a connection to memory interface 520 to communicate with I/O unit 508, as well as a connection to local parallel processing memory 506, thereby enabling the processing cores within the different GPCs 514 to communicate with system memory 404 or other memory that is not local to PPU 502. In the embodiment shown in FIG. 6, crossbar unit 518 is directly connected with I/O unit 508. Crossbar unit 518 may use virtual channels to separate traffic streams between the GPCs 514 and partition units 522.

Again, GPCs 514 can be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel shader programs), and so on. PPUs 502 may transfer data from system memory 404 and/or local parallel processing memories 506 into internal (on-chip) memory, process the data, and write result data back to system memory 404 and/or local parallel processing memories 506, where such data can be accessed by other system components, including CPU 402 or another parallel processing subsystem 420.

A PPU 502 may be provided with any amount of local parallel processing memory 506, including no local memory, and may use local memory and system memory in any combination. For instance, a PPU 502 can be a graphics processor in a unified memory architecture (UMA) embodiment. In such embodiments, little or no dedicated graphics (parallel processing) memory would be provided, and PPU 502 would use system memory exclusively or almost exclusively. In UMA embodiments, a PPU 502 may be integrated into a bridge chip or processor chip or provided as a discrete chip with a high-speed link (e.g., PCI-EXPRESS) connecting the PPU 502 to system memory via a bridge chip or other communication means.

As noted above, any number of PPUs 502 can be included in a parallel processing subsystem 420. For instance, multiple PPUs 502 can be provided on a single add-in card, or multiple add-in cards can be connected to communication path 416, or one or more of PPUs 502 can be integrated into a bridge chip. PPUs 502 in a multi-PPU system may be identical to or different from one another. For instance, different PPUs 502 might have different numbers of processing cores, different amounts of local parallel processing memory, and so on. Where multiple PPUs 502 are present, those PPUs may be operated in parallel to process data at a higher throughput than is possible with a single PPU 502. Systems incorporating one or more PPUs 502 may be implemented in a variety of configurations and form factors, including desktop, laptop, or handheld personal computers, servers, workstations, game consoles, embedded systems, and the like.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

Apparently, the aforementioned embodiments are merely examples illustrated for clearly describing the present application, rather than limiting the implementation ways thereof. For a person skilled in the art, various changes and modifications in other different forms may be made on the basis of the aforementioned description. It is unnecessary and impossible to exhaustively list all the implementation ways herein. However, any obvious changes or modifications derived from the aforementioned description are intended to be embraced within the protection scope of the present application.

The example embodiments may also provide at least one technical solution to a technical challenge. The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

The terms “including,” “comprising” and variations thereof, as used in this disclosure, mean “including, but not limited to,” unless expressly specified otherwise.

The terms “a,” “an,” and “the,” as used in this disclosure, means “one or more,” unless expressly specified otherwise.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, may comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

While the disclosure has been described in terms of exemplary embodiments, those skilled in the art will recognize that the disclosure can be practiced with modifications that fall within the spirit and scope of the appended claims. These examples given above are merely illustrative and are not meant to be an exhaustive list of all possible designs, embodiments, applications, or modification of the disclosure.

In summary, the integrated circuit with a plurality of transistors, each of which may have a gate dielectric with properties independent of the gate dielectric for adjacent transistors provides for the ability to fabricate more complex circuits on a semiconductor substrate. The methods of fabricating such an integrated circuit structures further enhance the flexibility of integrated circuit design. Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. A computer-implemented method for reassigning memory access as a function of physical location information of a memory group comprising:
identifying a physical location of an agent in a multi-agent system;
determining memory access requests from instructions of the agent;
based on the physical location of the agent, determining a group of memory units having a physical location that is closest to the physical location of the agent; and
assigning the determined memory access requests to the group of memory units.

2. The computer-implemented method of claim 1, wherein determining the group of memory units comprises retrieving data corresponding to the physical location of the group of memory units.

3. The computer-implemented method of claim 1, wherein determining the group of memory units comprises determining a presence of a priority data.

4. The computer-implemented method of claim 3, further comprising assigning the determined memory access requests to the group of memory units based on the priority data.

5. The computer-implemented method of claim 1, wherein the physical location of the group of memory units comprises the physical location identifying horizontal or vertical information relative to the agent.

6. A graphics processing subsystem for reassigning memory access as a function of physical location information of a memory group comprising:
a graphics processing unit (GPU) operable to:
identifying a physical location of an agent in a multi-agent system;
determining memory access requests from instructions of the agent;
based on the physical location of the agent, determining a group of memory units having a physical location that is closest to the physical location of the agent; and
assigning the determined memory access requests to the group of memory units.

7. The graphics processing subsystem of claim 6, wherein determining the group of memory units comprises retrieving data corresponding to the physical location of the group of memory units.

8. The graphics processing subsystem of claim 6, wherein determining the group of memory units comprises determining a presence of a priority data.

9. The graphics processing subsystem of claim 8, further comprising assigning the determined memory access requests to the group of memory units based on the priority data.

10. The graphics processing subsystem of claim 6, wherein the physical location of the group of memory units comprises the physical location identifying horizontal or vertical information relative to the agent.

11. A system for reassigning memory access as a function of physical location information of a memory group comprising:
a memory that is configured to store instructions for execution by an agent;
a graphics processing unit (GPU) configured to execute serialized algorithms instructions, wherein the GPU is configured to:
identifying a physical location of an agent in a multi-agent system;
determining memory access requests from instructions of the agent;
based on the physical location of the agent, determining a group of memory units having a physical location that is closest to the physical location of the agent; and
assigning the determined memory access requests to the group of memory units.

12. The system of claim 11, wherein determining the group of memory units comprises retrieving data corresponding to the physical location of the group of memory units.

13. The system of claim 11, wherein determining the group of memory units comprises determining a presence of a priority data.

14. The system of claim 13, further comprising assigning the determined memory access requests to the group of memory units based on the priority data.

15. The system of claim 11, wherein the physical location of the group of memory units comprises the physical location identifying horizontal or vertical information relative to the agent.

16. The system of claim 11, further comprising a multi-channel buffer allocated to the determined group of memory units for storing data to resolve return path conflict issues.
